(19) United States
(12) Patent Application Publication
(10) Pub. No.: US 2007/0176445 A1
(43) Pub. Date: Aug. 2, 2007

(54) Apparatus and method for transferring wafers

(76) Inventor: Jin-Sung Kim, Hwaseong-si (KR)

Correspondence Address: LEE & MORSE, P.C., 3141 FAIRVIEW PARK DRIVE, SUITE 500, FALLS CHURCH, VA, 22042, US

(21) Appl. No.: 11/580,920

(22) Filed: Oct. 16, 2006

(30) Foreign Application Priority Data
Feb. 1, 2006 (KR) 2006/0009592

(51) Int. Cl. A47J 45/00

(52) U.S. Cl. 294/64.1

(57) ABSTRACT

An apparatus for transferring wafers and a method thereof, including a robotic arm, a transfer blade affixed to the robotic arm for holding at least one wafer, a wafer sensor unit coupled to the transfer blade, the wafer sensor unit having the capability of determining a position of the wafer relative to an optimal wafer position, and a controller electrically connected to the wafer sensor unit to terminate transfer operation if the wafer deviates from the optimal wafer position.

### BACKGROUND OF THE INVENTION

1. Field of the Invention

The present invention relates to wafer transfer equipment. In particular, the present invention relates to an apparatus and method for transferring wafers having a control system for detecting misaligned wafers, and, subsequently, terminating the transfer operation in order to minimize wafer damage.

2. Description of the Related Art

In general, manufacturing of semiconductor devices may require multiple-step wafer processing. Such processing may involve employing a robotic arm having a holding means, e.g., a clamp or a transfer blade, to secure wafers and transfer them from one processing station or location to another. For example, the robotic arm may be used to move a wafer from a cassette into a process chamber, and, subsequently, to remove the wafer from the process chamber at the end of the processing step in order to load it back into the cassette for further processing.

The robotic arm may be designed to transfer a plurality of wafers simultaneously or one by one, and the holding means of the robotic arm may be formed to hold a wafer placed thereon mechanically or to secure the wafer with vacuum pressure. Regardless of the holding means, the positioning of the wafer on the robotic arm may be important, and any wafer misalignment, due to lifting pins, vibrations, and so forth, may trigger wafer collision or fall during transfer.

For example, a wafer unloaded from a heating plate by a plurality of lifting pins may be misaligned, when the speed of movement and/or contact intensity between the lift pins and the wafer is too large or non-uniform. Accordingly, during wafer transfer, the wafer may be insecurely positioned on the robotic arm, thereby increasing the potential for incorrect loading, fracturing, wafer damage, and overall manufacturing process flaws.

Therefore, there exists a need for a device for transferring wafers having improved control of wafer positioning thereon.

### SUMMARY OF THE INVENTION

The present invention is therefore directed to an apparatus and method for transferring wafers that substantially overcome one or more of the problems due to the limitations and disadvantages of the related art.

It is therefore a feature of an embodiment of the present invention to provide an apparatus for transferring wafers having a control system for detecting misaligned wafer.

It is another feature of an embodiment of the present invention to provide an apparatus for transferring wafers capable of minimizing wafer damage during semiconductor manufacturing processes.

It is yet another feature of an embodiment of the present invention to provide a method for transferring wafers having an improved control of wafer positioning and overall transfer operation.

At least one of the above and other features and advantages of the present invention may be realized by providing an apparatus for transferring wafers, including a robotic arm, a transfer blade for holding at least one wafer, the transfer blade may be affixed to the robotic arm, a wafer sensor unit coupled to the transfer blade, the wafer sensor unit may have the capability of determining a position of the wafer relative to an optimal wafer position, and a controller electrically connected to the wafer sensor unit.

The wafer sensor unit may include at least one vacuum aperture, a pressure sensor, and at least one vacuum line in fluid communication with the vacuum aperture and the pressure sensor. The vacuum aperture may be formed through the transfer blade at a predetermined distance from a connection point between the robotic arm and the transfer blade. The wafer sensor unit may also include a plurality of vacuum apertures.

Alternatively, the wafer sensor unit may include a photo sensor. The photo sensor may be formed on an upper surface of the transfer blade.

The apparatus for transferring wafers in accordance with an embodiment of the present invention may additionally include a vacuum port communicating through the transfer blade. In this case, the wafer sensor unit may include at least one vacuum aperture, a pressure sensor, a first vacuum line, and a second vacuum line. The first vacuum line may be in fluid communication with the vacuum aperture and the pressure sensor. The second vacuum line may be in fluid communication with the first vacuum line and the vacuum port.

In another aspect of the present invention there is provided a method for controlling transfer of wafers, including placing a wafer on a top surface of a transfer blade, activating a wafer sensor unit to determine a position of the wafer on the transfer blade relative to an optimal wafer position, transmitting a signal to a controller to indicate the position of the wafer on the transfer blade, and controlling a movement of the transfer blade with the wafer in response to the signal transmitted to the controller.

Controlling the movement of the transfer blade may include transferring the wafer to a next processing step, when the position of the wafer is the optimal wafer position. Alternatively, controlling the movement of the transfer blade may include terminating an operation of the transfer blade, when the position of the wafer deviates from the optimal wafer position.

Activating a wafer sensor unit may include activating vacuum pressure through a vacuum aperture communicating through the transfer blade. Further, activating the vacuum pressure may include releasing vacuum pressure through a vacuum line in fluid communication with the vacuum aperture and a pressure sensor, such that the pressure sensor is capable of determining the position of the wafer with respect to a measured pressure.

Activating a wafer sensor unit may also include operating of a pressure sensor or a photo sensor. Further, placing a wafer on the top surface of the transfer blade may include securing the wafer to the transfer blade with vacuum.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a perspective view of an apparatus for transferring wafers according to an embodiment of the present invention;

FIG. 2 illustrates a top view of an apparatus for transferring wafers, according to an embodiment of the present invention;

FIG. 3 illustrates a top view of an apparatus for transferring wafers, according to another embodiment of the present invention;

FIG. 4 illustrates a cross-sectional view of an apparatus for transferring wafers, according to an embodiment of the present invention;

FIG. 5 illustrates a perspective view of an apparatus for transferring wafers, according to another embodiment of the present invention;

FIG. 6 illustrates a perspective view of an apparatus for transferring wafers, according to another embodiment of the present invention;

FIG. 7 illustrates a partially magnified cross-sectional view of a vacuum port, according to an embodiment of the present invention; and

FIG. 8 illustrates a flowchart of a method for transferring wafers, according to an embodiment of the present invention.

### DETAILED DESCRIPTION OF THE INVENTION

Korean Patent Application No. 10-2006-0009592, filed Feb. 1, 2006, and entitled: “Apparatus and Method for Transferring Wafers,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of elements and regions are exaggerated for clarity of illustration.

It will also be understood that when an element is referred to as being “on” another element or substrate, it can be directly on the other element or substrate, or intervening elements may also be present. Further, it will be understood that when an element is referred to as being “under” another element, it can be directly under, or one or more intervening elements may also be present. In addition, it will also be understood that when an element is referred to as being “between” two elements, it can be the only element between the two elements, or one or more intervening elements may also be present. Like reference numerals refer to like elements throughout.

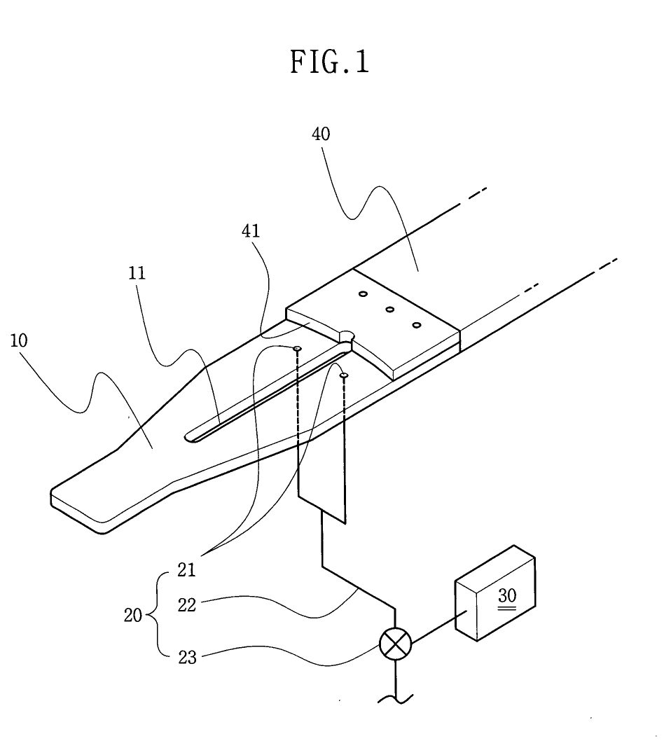

An exemplary embodiment of the present invention will now be more fully described with respect to FIG. 1, which illustrates a perspective view of an embodiment of an apparatus for transferring wafers.

As illustrated in FIG. 1, an apparatus for transferring wafers according to an embodiment of the present invention may include a robotic arm 40, a transfer blade 10 for holding at least one wafer, a wafer sensor unit 20 for determining the position of a wafer on the transfer blade 10, and a controller 30.

The transfer blade 10 in accordance with an embodiment of the present invention may be formed in any shape known in the art for conveniently holding and transferring wafers. In particular, the transfer blade 10 may be formed at a front end of the robotic arm 40 in such a way that the front end of the robotic arm 40 and the back end of the transfer blade 10 may partially overlap. More specifically, the robotic arm 40 may be affixed to an upper surface of the transfer blade 10, such that a front edge of the robotic arm 40 may form a vertical surface with respect to the upper surface of the transfer blade 10 to form a guide wall 41, as shown in FIG. 1.

The guide wall 41 may have a predetermined height, i.e., thickness of the robotic arm 40, and it may be formed to have a curvature having the same dimensions as an outer circumference of a wafer. Accordingly, once a wafer is placed on the transfer blade 10, the wafer's horizontal movement, i.e., motion along the transfer blade 10 towards the robotic arm 40, may be restricted by the guide wall 41. In this respect, it should be noted that the transfer blade 10 may be formed such that a single wafer may be simply placed thereon, i.e., no specialized securing means may be incorporated.

The transfer blade 10 may further include a slot 11, as shown in FIG. 1. The slot 11 may preferably be formed along a center of the upper surface of the transfer blade 10 in a direction parallel to that of the robotic arm 40.

The transfer blade 10 may be formed of any suitable material known in the art. In particular, the transfer blade 10 may be formed of metal, silicon, ceramic material, or any other suitable material.

The wafer sensor unit 20 in accordance with an embodiment of the present invention may include at least one vacuum aperture 21, at least one vacuum line 22, and a pressure sensor 23. More specifically, the wafer sensor unit 20 may include at least one vacuum line 22 in fluid communication with the vacuum aperture 21 and the pressure sensor 23, such that application of vacuum pressure to the vacuum aperture 21 through the vacuum line 22 may facilitate pressure measurement by the pressure sensor 23. Such pressure measurement may determined pressure change as a result of a partial or complete blocking of the vacuum aperture 21. In other words, a presence of an object, e.g., a wafer, that may block partially or completely the vacuum aperture 21 may modify the vacuum pressure measured by the pressure sensor 23, thereby indicating the position of the object, i.e., the wafer, relatively to the vacuum aperture 21 or the optimal wafer position as will be discussed in detail below.

The number of vacuum apertures 21 in the wafer sensor unit 20 may be one or two. The vacuum apertures 21 may be formed through the transfer blade 10, and they may be connected via at least one vacuum line 22 to a pressure sensor 23.

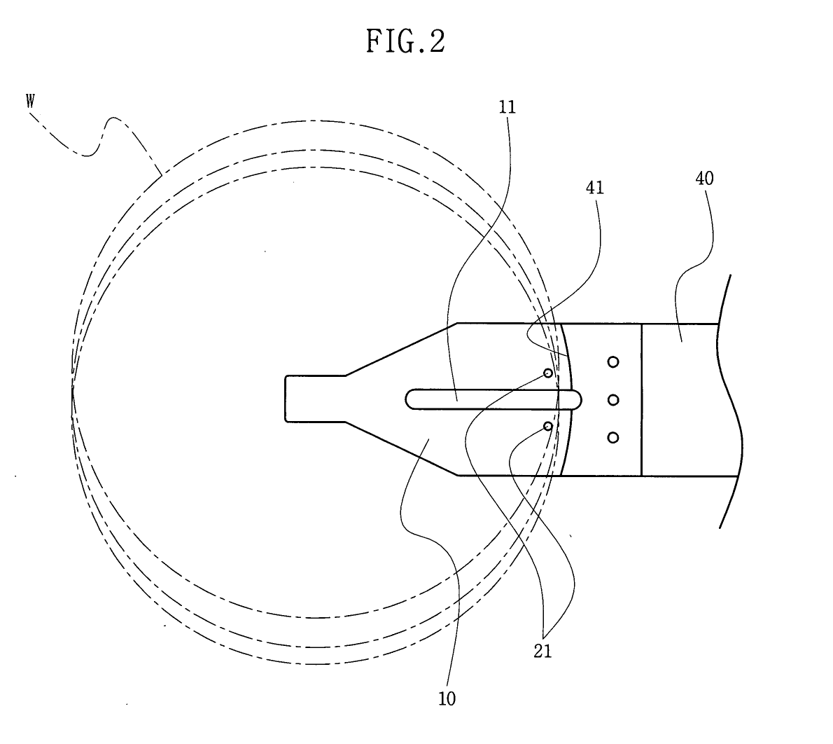

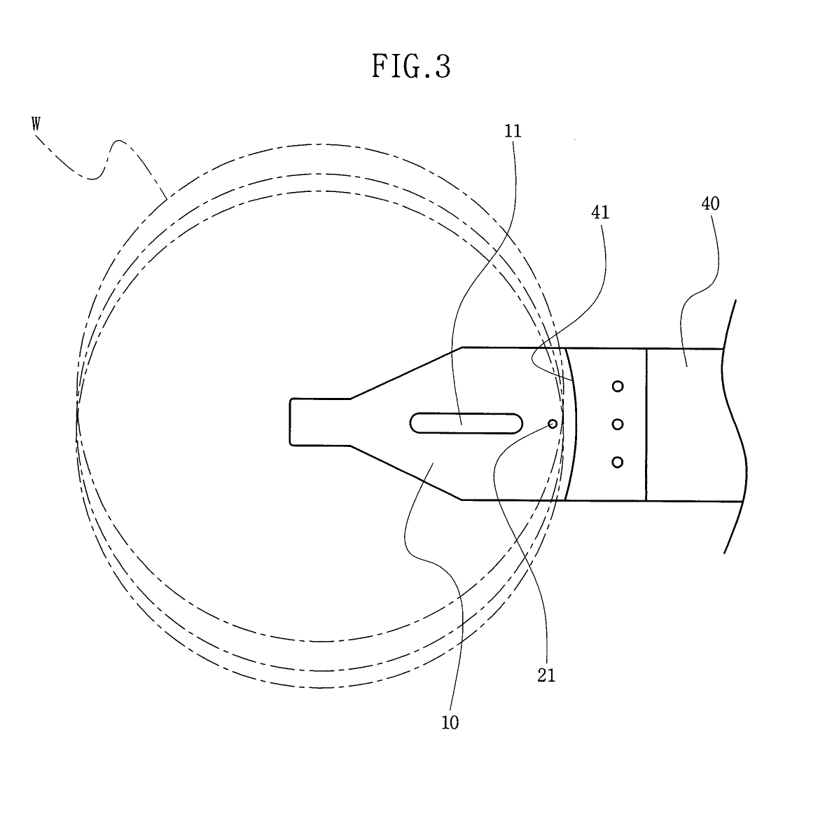

The formation and location of vacuum apertures 21 will be more fully described with respect to FIGS. 2-3. The vacuum apertures 21 may be formed through the transfer blade 10 within an optimal wafer range. More preferably, the vacuum apertures 21 may be formed within the optimal wafer range at a predetermined distance from the guide wall 41, as illustrated in FIG. 2-3. The predetermined distance from the guide wall 41 refers to a minimum distance set between the vacuum apertures 21 and the guide wall 41, such that the vacuum apertures 21 may not be formed directly adjacent to and/or in contact with the guide wall 41.

In this respect, it also should be noted that an “optimal wafer range” refers to a range within the upper surface of the transfer blade 10 for placing a wafer thereon, such that a stable withdrawal, i.e., movement of a wafer without the risk of falling or colliding with any structure, from a process chamber by a robotic arm 40 may be provided. In other words, a wafer placed within the optimal wafer range may have minimized chances of falling off of the blade 10. The outermost radial limit of the optimal wafer range, i.e., a position at which a wafer is placed closest to the robotic arm 40, may be the guide wall 41. It should further be noted that a position of a wafer placed within the “optimal wafer range” may be referred to as an “optimal wafer position.” Examples of optimal wafer positions are illustrated by the plurality of broken lines W in FIGS. 2-3.

The location and structure of the vacuum apertures 21 may also depend on the shape and size of slot 11. For example, if slot 11 is short, i.e., slot 11 is formed such that at least one vacuum aperture 21 may be formed along the centre line of the transfer blade 10 between slot 11 and the outermost limit of the optimal wafer range, a single vacuum aperture 21 may be formed through the surface of the transfer blade 10. Preferably, the single vacuum aperture 21 may be formed along the center line of the transfer blade 10, as can be seen in FIG. 3. Alternatively, if slot 11 is long, e.g., slot 11 does not fit within the optimal wafer range, two vacuum apertures 21 may be formed through the transfer blade 10. In particular, one vacuum aperture 21 may be formed on each side of the slot 11, as illustrated in FIG. 2.

The vacuum line 22 of the wafer sensor unit 20 may connect the vacuum apertures 21 to the pressure sensor 23, such that vacuum pressure may be supplied and measured. The vacuum supplied into the vacuum line 22 may be generated by a separate vacuum generator such as a vacuum pump (not shown), and the vacuum generated by the vacuum pump may be delivered to the vacuum apertures 21 through the vacuum line 22. If the wafer sensor unit 20 includes more than one vacuum line 22, e.g., a separate vacuum line (not shown) may be attached to each vacuum aperture 21, the vacuum pump may provide vacuum to each separate vacuum line 22.

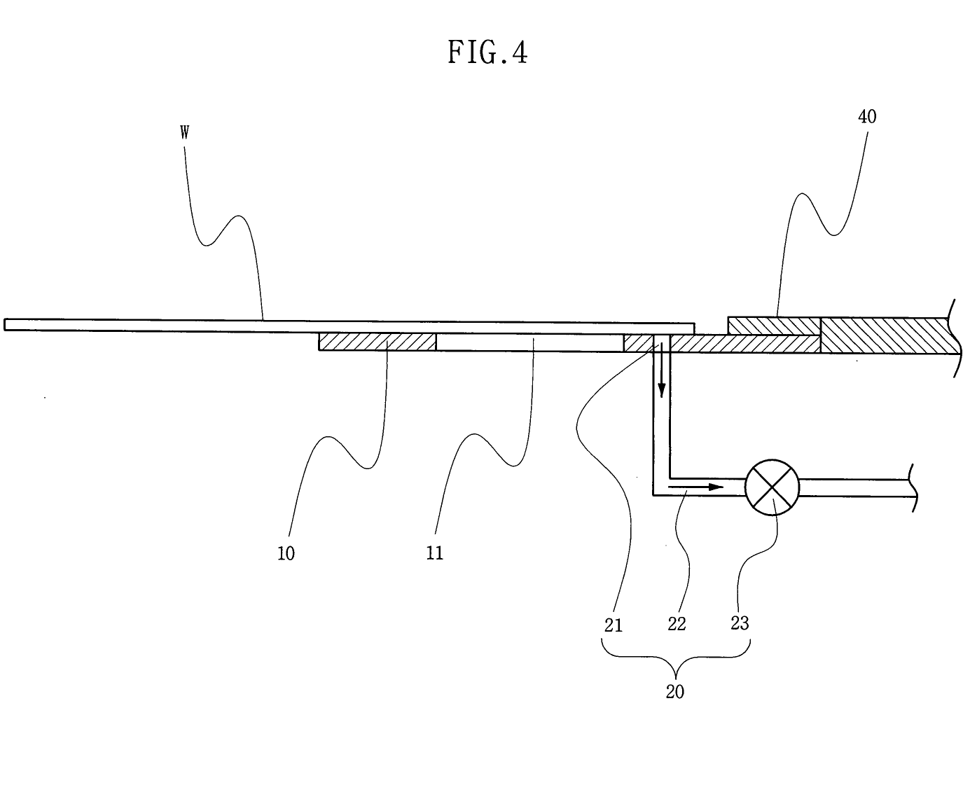

Accordingly, as illustrated in FIG. 4, when a wafer W is positioned at an optimal wafer position on the transfer blade 10, the wafer W may completely cover vacuum apertures 21 formed in the transfer blade 10. Consequently, when vacuum is delivered to the vacuum apertures 21 through the vacuum line 22, the wafer W may be attached to the transfer blade 10 by the vacuum pressure, thereby modifying the vacuum pressure sensed by the vacuum sensor 23 and indicating the presence of an object, e.g., wafer W, at an optimal wafer position.

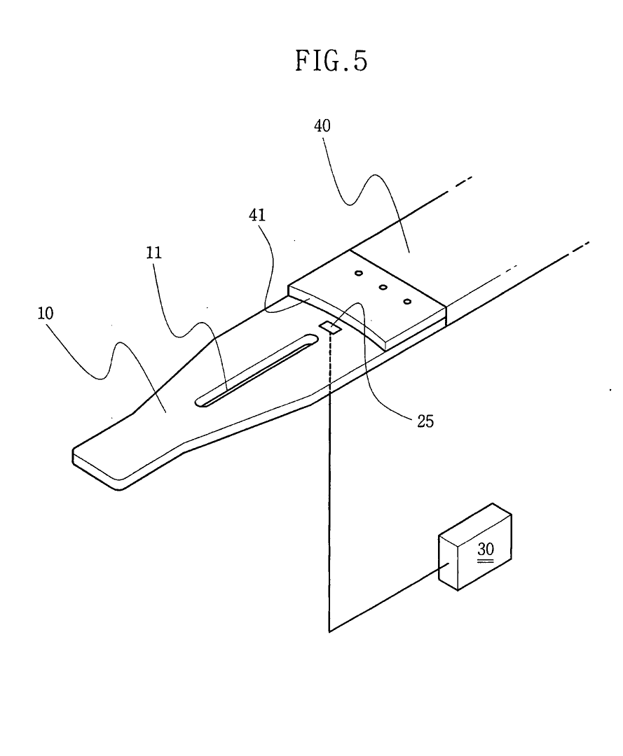

The wafer sensor unit 20 of the present invention may include additional and/or alternative sensors for facilitating determination of a wafer location on the transfer blade 10. Such sensors may include, inter alia, a photo sensor 25, as shown in FIG. 5. For example, a photo sensor 25 may be installed in the upper surface of the transfer blade 10 within the optimal wafer range, such that when a wafer is located within the optimal wafer range on the transfer blade 10, the wafer may be detected by the photo sensor 25.

The controller 30 in accordance with an embodiment of the present invention may be electrically connected to the wafer sensor unit 20, such that the controller 30 may receive a signal from the wafer sensor unit 20, e.g., either through the pressure sensor 23 or through the photo sensor 25, indicating the location of the wafer with respect to the optimal wafer range. In other words, the controller 30 may receive one type of signal indicating that the wafer is at the optimal wafer position. Alternatively, the controller 30 may receive another type of signal indicating that the wafer is not at the optimal wafer position.

If the wafer sensor unit 20 indicates that the wafer is located at the optimal wafer position on the transfer blade 10, the controller 30 may allow the wafer transfer operation to proceed, i.e., the robotic arm 40 may continue transferring the wafer to a cassette or to the next processing step. If the wafer sensor unit 20 indicates that the wafer is not located at the optimal wafer position, e.g., a wafer may be placed incorrectly onto the transfer blade 10 such that any motion of the robotic arm 40 may topple and damage it, the controller 30 may stop the wafer transfer in order to minimize any potential damage to the wafer and/or the overall process.

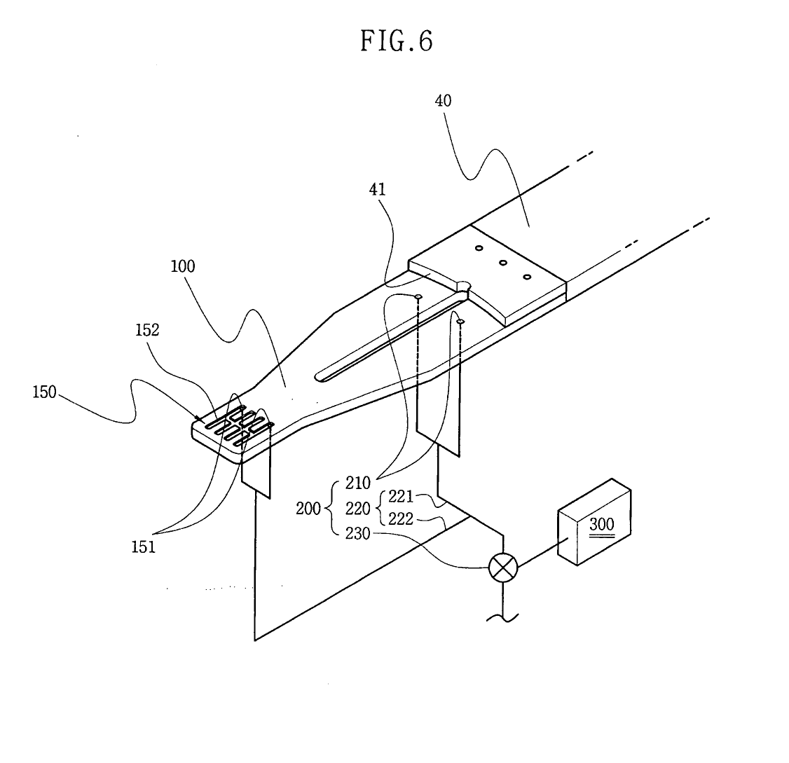

In another embodiment of the present invention illustrated in FIG. 6, the apparatus for transferring wafers may include a robotic arm 40, a transfer blade 100, a vacuum port 150 formed on a top surface of the transfer blade 100, a wafer sensor unit 200 to determine a wafer's location on the transfer blade 100, and a controller 300 to control the wafer transfer operation.

It is noted that the particular elements included in the embodiment illustrated in FIG. 6, as well as the overall method of operation of the wafer transfer apparatus, is similar to the description provided previously with respect to the wafer transfer apparatus illustrated in FIGS. 1-5. Accordingly, only details that may be distinguishable from the previous embodiment will be described hereinafter. Details and descriptions that may be found in both embodiments of the wafer transfer apparatus illustrated in FIGS. 1-7 will not be repeated herein.

In accordance with the embodiment illustrated in FIG. 6, a vacuum port 150 may be formed through the upper surface of the transfer blade 100 in order to stably secure a wafer to the transfer blade 100. The vacuum port 150 may be formed at the front end of the transfer blade 100, i.e., the side of the transfer blade 100 that is opposite to the robotic arm 40. It should be noted that the vacuum port 150 may be employed as a means for securing a wafer onto the transfer blade 100, and it may not be employed as a vacuum delivery system for determining a wafer's position on the blade 100.

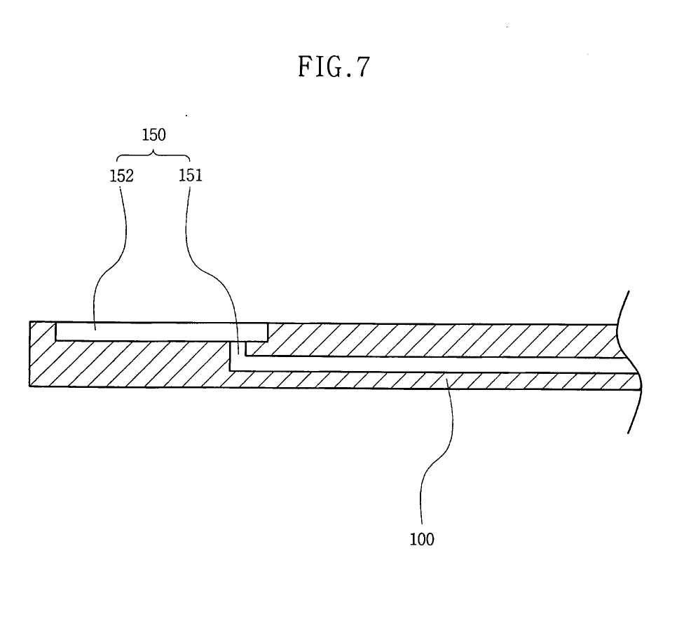

The vacuum port 150, as illustrated in FIGS. 6-7, may include at least one vacuum aperture 151 through which vacuum may be introduced, and at least one vacuum groove 152, which may be in fluid communication with at least one vacuum aperture 151. Once vacuum pressure is introduced to the vacuum port 150 through the vacuum aperture 151 and the vacuum groove 152, a wafer placed thereon may be firmly attached to the transfer blade 100, thereby minimizing the risk of unstable wafer transfer.

The vacuum groove 152 may be formed in any known and/or convenient shape in the art at the top surface of the transfer blade 100, such that the vacuum groove 152 is in fluid communication with the vacuum aperture 151. The overall cross-sectional area of the vacuum groove 152 may be larger than the cross-sectional area of the vacuum aperture 151. Without intending to be bound by theory, it is believed that an increased cross-sectional area of the vacuum groove 152 may increase the overall surface area employed by vacuum pressure for securing a wafer to the transfer blade 100.

In accordance with the embodiment illustrated in FIG. 6, the wafer sensor unit 200 may be designed to determine whether or not a wafer is positioned at an optimal wafer position on the transfer blade 100. The wafer sensor unit 200 may be operated as soon as a wafer is secured by vacuum pressure to the vacuum port 150 of the transfer blade 100.

As further illustrated in FIG. 6, the wafer sensor unit 200 may include at least one vacuum aperture 210, at least one vacuum line 220, and a pressure sensor 230. Alternatively, the wafer sensor unit 200 may include a photo sensor. The number of the vacuum apertures 210 may be any number as may be determined by a person skilled in the art, and, preferably, the number of the vacuum apertures 210 may be one or two. It should be noted, however, that the size of the vacuum apertures 210 may be small, because the vacuum apertures 210 may be intended to determine the presence of a wafer, and not secure it to the transfer blade 100 as it is with the vacuum port 150.

The vacuum supplied into the wafer sensor unit 200 may be generated by a separate vacuum generator such as a vacuum pump (not shown). The vacuum pump may also simultaneously supply vacuum to the vacuum port 150. If a single vacuum pump supplies vacuum to the vacuum apertures 210 and the vacuum port 150, the vacuum line 220 may include a first vacuum line 221 and a second vacuum line 222. The first vacuum line 221 may be in fluid communication with the vacuum apertures 210, and the second vacuum line 222 may be in fluid communication with the vacuum port 150. Alternatively, the vacuum to the vacuum port 150 may be provided by a separate independent vacuum supply mechanism.

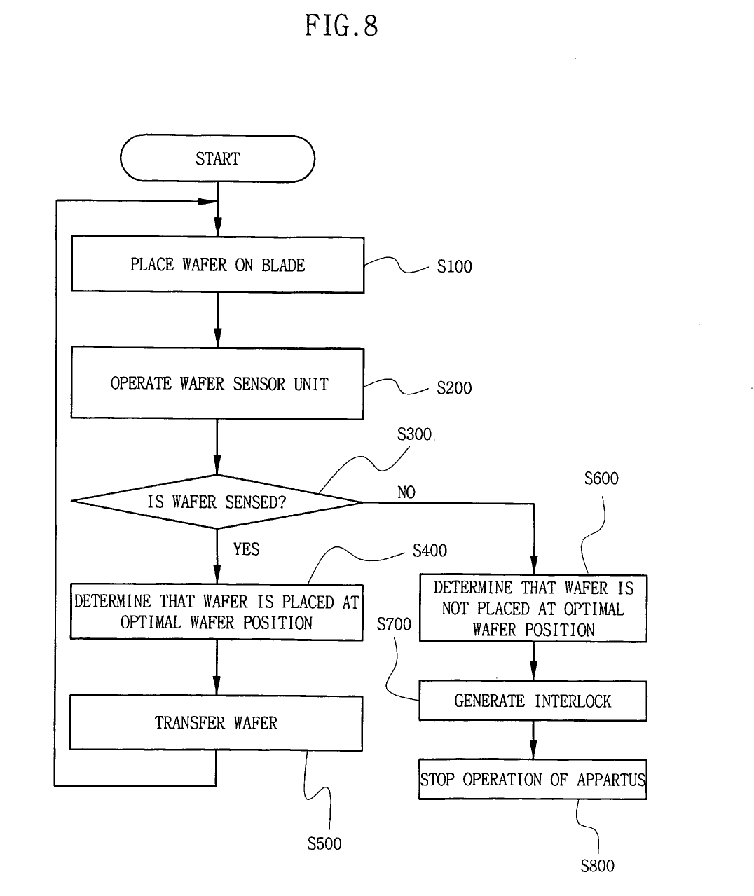

In accordance with another embodiment of the present invention, a method for transferring wafers will be discussed in detail below with respect to FIG. 8. It should be noted that the exemplary method illustrated herein is described with respect to exemplary apparatus embodiments discussed previously with respect to FIGS. 1-7. However, other embodiments of apparatuses for wafer transfer are not excluded from the scope of the present inventive method.

As illustrated in FIG. 8, the first step, i.e., step S100, may include placement of a wafer on a top surface of the transfer blade 10 or 100. Step S100 may be performed regardless of the exact wafer location on the upper surface of the transfer blade 10 or 100. In other words, step S100 may be performed even if a wafer is not at its optimal wafer position. In this respect, it is noted that “placement of a wafer on a transfer blade” refers to a process at which a wafer may be withdrawn from one manufacturing step, e.g., process chamber, and transferred to another manufacturing step or to a cassette.

The wafer may be placed onto the transfer blade 10 or 100 by any method known in the art. For example, when a wafer is removed from a load-lock chamber, transfer blade 10 or 100 may rise to a predetermined height and enter between slots such that the wafer is positioned thereon. In other chamber types, lift pins may be employed to raise the wafer from the chamber and, subsequently, lower the wafer onto transfer blade 10 or 100.

Once the wafer is placed onto the transfer blade 10 or 100, the next step, i.e., S200, may include operation of the wafer sensing unit 20 or 200 to determine the wafer's position. Operation of the wafer sensor unit 20 or 200 may include introduction of vacuum pressure through the vacuum lines 22 or 220, respectively, and activation of the pressure sensor unit 23 or 230, respectively. Alternatively, the operation of the wafer sensor unit 20 or 200 may include activation of a photo sensor, e.g., photo sensor 25. Activation of pressure sensor unit 23 or 230, or a photo sensor for the purpose of determining whether the wafer is positioned at an optimal wafer position may be performed in step S300.

Next, as illustrated in FIG. 8, the wafer transfer method may be continued or discontinued with respect to the results determined by the wafer sensor unit 20 or 200 in steps S400 and S600.

In particular, when the wafer sensor unit 20 or 200 determines in step S400 that the wafer is positioned at an optimal wafer position, a signal may be transmitted to the controller 30 or 300 to indicate the optimal position. Subsequently, at step S500, the robotic arm 40 may continue its progress and may transfer the wafer to the next manufacturing process step or a cassette.

Alternatively, when the wafer sensor unit 20 or 200 determines at step S600 that the wafer is not at the optimal wafer position, an appropriate signal may be transmitted to the controller 30 or 300. Subsequently, at step S700, the controller 30 or 300 may generate an interlock signal, which pauses operation of the wafer transfer apparatus, i.e., step S800.

Accordingly, when a wafer is not located at the optimal wafer position, i.e., whether it is misplaced or completely missing, or alternatively, when the wafer is not sensed by the wafer sensor unit 20 or 200, the apparatus and method according to an embodiment of the present invention may trigger an interlock and terminate the wafer transfer operation, thereby minimizing wafer damage and overall economic loss.

The wafer's misalignment on the transfer blade 10 or 100 may be detected as soon as the wafer is placed on the transfer blade 10 or 100. Such early misalignment detection may minimize process errors and optimize adjustment, thereby providing enhanced process and apparatus efficiency of the apparatus and overall wafer throughput.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An apparatus for transferring wafers, comprising:
a robotic arm;
a transfer blade for holding at least one wafer, the transfer blade being affixed to the robotic arm;
a wafer sensor unit coupled to the transfer blade, the wafer sensor unit having the capability of determining a position of the wafer relative to an optimal wafer position; and
a controller electrically connected to the wafer sensor unit.

2. The apparatus as claimed in claim 1, wherein the wafer sensor unit comprises at least one vacuum aperture, a pressure sensor, and at least one vacuum line in fluid communication with the vacuum aperture and the pressure sensor.

3. The apparatus as claimed in claim 2, wherein the vacuum aperture is formed through the transfer blade at a predetermined distance from a connection point between the robotic arm and the transfer blade.

4. The apparatus as claimed in claim 2, wherein the wafer sensor unit comprises a plurality of vacuum apertures.

5. The apparatus as claimed in claim 1, wherein the wafer sensor unit comprises a photo sensor.

6. The apparatus as claimed in claim 5, wherein the photo sensor is on an upper surface of the transfer blade.

7. The apparatus as claimed in claim 1, further comprising a vacuum port communicating through the transfer blade.

8. The apparatus as claimed in claim 7, wherein the wafer sensor unit comprises at least one vacuum aperture, a pressure sensor, a first vacuum line, and a second vacuum line.

9. The apparatus as claimed in claim 8, wherein the first vacuum line is in fluid communication with the vacuum aperture and the pressure sensor.

10. The apparatus as claimed in claim 8, wherein the second vacuum line is in fluid communication with the first vacuum line and the vacuum port.

11. A method for controlling transfer of wafers, comprising:
placing a wafer on a top surface of a transfer blade;
operating a wafer sensor unit to determine a position of the wafer on the transfer blade relative to an optimal wafer position;
transmitting a signal to a controller to indicate the position of the wafer on the transfer blade; and
controlling a movement of the transfer blade with the wafer in response to the signal transmitted to the controller.

12. The method as claimed in claim 11, wherein controlling the movement of the transfer blade comprises transferring the wafer to a next processing step, when the position of the wafer is the optimal wafer position.

13. The method as claimed in claim 11, wherein controlling the movement of the transfer blade comprises terminating an operation of the transfer blade, when the position of the wafer deviates from the optimal wafer position.

14. The method as claimed in claim 11, wherein operating a wafer sensor unit comprises activating vacuum pressure through a vacuum aperture communicating through the transfer blade.

15. The method as claimed in claim 14, wherein activating the vacuum pressure comprises releasing vacuum pressure through a vacuum line in fluid communication with the vacuum aperture and a pressure sensor, such that the pressure sensor is capable of determining the position of the wafer with respect to a measured pressure.

16. The method as claimed in claim 11, wherein operating a wafer sensor unit comprises operating of a pressure sensor or a photo sensor.

17. The method as claimed in claim 11, wherein placing a wafer on the top surface of the transfer blade comprises securing the wafer to the transfer blade with vacuum.
